(19) United States
(12) Patent Application Publication
(10) Pub. No.: US 2025/0143251 A1
(43) Pub. Date: May 8, 2025

(54) ORGANIC MATERIAL PELLETS

(71) Applicant: The Andersons Inc., Maumee, OH (US)

(72) Inventors: Edward Sharek, Maumee, OH (US); Norman Peiffer, Maumee, OH (US)

(73) Assignee: The Andersons Inc., Maumee, OH (US)

(21) Appl. No.: 18/939,859

(22) Filed: Nov. 7, 2024

Related U.S. Application Data
(60) Provisional application No. 63/547,431, filed on Nov. 6, 2023.

(51) Int. Cl. A01K 1/015

(52) U.S. Cl. CPC A01K 1/0155

(57) ABSTRACT

Organic material pellets that are highly absorbent and have natural odor suppressing ability for use as an environmentally friendly animal litter or bedding requiring less frequent changes and disposal, relative to conventional litters and bedding. The organic material pellets include a plurality of feedstock pieces of at least two of a paper material, a wood material, an agricultural waste material, and a cellulosic material combined together and formed into a plurality of the organic material pellets. The feedstock pieces of the organic material pellets are a majority by weight of recycled materials or waste materials, making the organic material pellets an upcycled product and thereby reducing the need for new production from virgin resources.

### RELATED APPLICATIONS

This application claims priority benefit of U.S. Provisional Application Ser. No. 63/547,431, filed on 6 Nov. 2023; the contents of which are hereby incorporated by reference.

### FIELD OF THE INVENTION

The invention in general relates to an organic material and, in particular, to an environmentally friendly pelletized material useful as animal litter or bedding.

### BACKGROUND OF THE INVENTION

Pets, such as cats, hamsters, gerbils, ferrets, mice, and the like, and hobby farm animals, such as horses, donkeys, avians, and goats often utilize boxes, crates, stalls, or pens that require convenient short-term accommodation of animal waste products. The typical solution to this need for household animals is the device commonly known as the litter box. A litter box is generally a shallow open container containing material used for the accommodation of animal waste that is accessible to the pet for indoor urine and feces disposal to simulate the natural instincts of animals to excrete in soft soil for easy burial. For farm animals, floors of stalls and pens are typically lined with straw, hay, or other bedding material to provide warmth and softness and for the absorption of animal waste. Traditionally, materials used for the accommodation of animal waste are made of an absorbent material such as clay, gypsum, diatomaceous earth, alfalfa, wood chips or shavings, sawdust, paper, recycled paper, foam, silicate-based granular material, or even plastic that is intended to be disposed of along with the animal waste. A deodorant or fragrance may be added to mask the odor of the urine and feces.

For some animals, such as small animals such as mice, hamsters, and gerbils, the litter box is integral to the habit cages or shoe box cages is essentially the living surface of the animal. In such instances, the litter is also referred to as bedding. Such living spaces require frequent changes of the litter to keep cages clean and sanitary. Laboratory animals also require a non-toxic litter to reduce the effect of the environment on animal testing.

The upkeep of an animal waste area is crucial to the comfort of an animal and/or enjoyment of the animal by its owner. Specifically, the animal will interact with the designated animal waste area while relieving itself. After a period of time, however, the litter or bedding will reach a sanitarily unacceptable condition. At this point, the litter or bedding must be discarded and replaced with new material; else, the animal may reject the animal waste area and instead seek alternate locations, such as rugs, floors, furniture, and plants, on which to relieve itself. For animals which essentially live in their own litter box, keeping the litter or bedding clean is a major environmental factor for the animal. Additionally, the sanitarily unacceptable litter or bedding will often produce an undesirable odor and may be of a non-hygienic nature and unpleasant for both the animal and the owner. Humans can contract toxoplasmosis from spent litter or bedding. Consequently, an animal owner must be extremely conscientious about replacing the litter or bedding on a timely basis.

The frequency with which litter or bedding must be changed is a direct function of the absorbency of the litter or bedding and its ability to suppress odors. The less absorbent the litter or bedding, the more often it must be changed. Many of the materials used for litter or bedding are not as absorbent as one might like, necessitating the frequent changing and disposal. A pet litter or bedding that is more absorbent than traditional litters helps to alleviate the problem of cleanliness by reducing the frequency with which the material needs to be changed. In addition, unless they have been chemically treated, many traditional litters have little ability to suppress the odors associated with animal waste. A litter or bedding that has the ability to suppress odors associated with animal waste would also help to decrease the frequency with which the material needs to be changed.

Conventional animal litter or bedding may generally be classified functionally into two categories based on the ability of the material to aggregate into removable clumps upon being wet with animal urine: clumping-litter and non-clumping litter. A common non-clumping pet litter is crystal pet litter. The ingredient of crystal pet litter is silica gel, having a micro-porous structure therein. The micro-porous structure is absorbent toward urine. Crystal pet litter has the advantages of licalong service life, little dust, and good cleanliness. However, crystal pet litter is expensive and has poor deodorization effect. Furthermore, some individual animals are adverse to silica gel and reject crystal pet litter. Silica may also cause diseases including silicosis.

In addition, traditional litters manufactured from clay or other minerals are relatively inexpensive and may contain chemical residues common to mined materials. These residues can be irritating both to the animal and the animal owner. Furthermore, these residues can be tracked about by an animal from a designated animal waste area. Additionally, many products used as animal litter, especially those clay-based litters, tend to generate appreciable amounts of dust. This dust, which often contains large amounts of silica, can be irritating to the eyes and throat of animals and humans alike. Similarly, traditional animal bedding formed of wood shavings are becoming increasingly expensive to manufacture.

Additionally, many traditional clay and mineral-based animal litters and beddings are also generally not bio-degradable and create a disposal problem, ultimately ending up in landfills. Given the frequency at which traditional pet litters or bedding must be disposed of and replaced, the amount of the materials disposed of in landfills leads to an appreciable volume of non-biodegradable waste.

Thus, there exists a need for an organic material pellet that is highly absorbent and has natural odor suppressing ability, requiring less frequent changes and disposal, relative to conventional litters and bedding. There additionally exists a need for an organic material pellet that is upcycled and thereby reduces the need for new production from virgin resources thereby fostering a circular flow of materials and contributes to a more sustainable and regenerative economic model.

### SUMMARY OF THE INVENTION

The present invention provides organic material pellets that are highly absorbent and have natural odor suppressing ability for use as an environmentally friendly animal litter or bedding requiring less frequent changes and disposal, relative to conventional litters and bedding. The organic material pellets include a plurality of feedstock pieces of at least two of a paper material, a wood material, an agricultural waste material, and a cellulosic material combined together and formed into a plurality of the organic material pellets. According to embodiments, the feedstock pieces of the organic material pellets are a majority by weight of recycled materials or waste materials, making the organic material pellets an upcycled product and thereby reducing the need for new production from virgin resources.

According to embodiments, the paper material when present is a virgin, recycled, or waste paper material or a paper derivative and/or is present in an amount of 0 to 99 total weight percent of the pellet. According to embodiments, the wood material when present is saw dust, wood scraps, wood shaving, wood chips, or a combination thereof and/or is present in an amount of 0 to 99 total weight percent of the pellet. According to embodiments, the agricultural waste material when present includes pulps, rinds, pits and seeds, wheat and corn mids and dust, cellulosic plant hulls, grain hulls, nut hulls, sunflower hulls, oat hulls, spelt hulls, soy hulls, and rice hulls, corncob, hemp, crushed hemp seed, bamboo, cellulosic plant stalks, plant stocks, cellulosic plant husks, beeswing wheat bran, tree bark, fronds, miscanthus, grasses, straw, kenaf, vegetable and fruit wastes, orange peels, or a combination thereof and/or is present in an amount of 0 to 99 total weight percent of the pellet. According to embodiments, the cellulosic material when present includes a carboxymethylcellulose, ethylcellulose, hydroxyethylcellulose, hydroxy-methylethylcellulose, hydroxyethylpropylcellulose, methylhydroxyethyl-cellulose, methylcellulose, cellulosic plant hull, grain hull, nut hull, sunflower hull, oat hull, spelt hull, soy hull, rice hull, or a combination thereof and/or is present in an amount of 0 to 99 total weight percent of the pellet.

### DETAILED DESCRIPTION OF THE INVENTION

The present invention has utility as organic material pellet operative to absorb animal urine and suppress odor with increased time increments between required material changing and disposal as compared to traditional animal litters and bedding. It is also lower in cost than most traditional litters and beddings over time, produces less dust, and is friendly in that it is made renewable sources and spent material may be used as a soil quality enhancer rather than being disposed of in a landfill. The pellets of the present invention when combined with typical layer of straw in a large animal stall reduces the frequency of stall pics and amount of straw consumed. It has been also shown many large animal stall compost piles take much longer to degrade than the more compostable substrates of the present invention.

In this disclosure, “comprises,” “comprising,” “containing” and “having” and the like can have the meaning ascribed to them in U.S. Patent law and can mean “includes,” “including,” and the like; “consisting essentially of or “consists essentially” likewise has the meaning ascribed in U.S. Patent law and the term is open-ended, allowing for the presence of more than that which is recited so long as basic or novel characteristics of that which is recited is not changed by the presence of more than that which is recited, but excludes prior art embodiments.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4. By way of further example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

Unless specifically stated or obvious from context, as used herein, the term “or” is understood to be inclusive. Unless specifically stated or obvious from context, as used herein, the terms “a,” “an,” and “the” are understood to be singular or plural.

Also, as used herein, “and/or” refers to and encompasses any and all possible combinations of one or more of the associated listed items, as well as the lack of combinations when interpreted in the alternative (“or”).

The suffix “(s)” as used herein is intended to include both the singular and the plural of the term that it modifies, thereby including one or more of that term.

The terms “litter” and “bedding” are used interchangeably herein with respect to the composition thereof, the difference in the terms stemming only from the intended use location of the material. That is, a “litter” is typically intended for use in a designated animal waste area, such as a litter box, that is separate from or only a small portion of where the animal resides, whereas a “bedding” is typically intended for use in a cage, stall, or pen where the animal lives and is kept for the most part.

Reference throughout the specification to “one embodiment”, “another embodiment”, “an embodiment”, and so forth, when present, means that a particular element (e.g., feature, structure, and/or characteristic) described in connection with the embodiment is included in at least one embodiment described herein, and may or may not be present in other embodiments. In addition, it is to be understood that the described elements may be combined in any suitable combination.

The present invention will now be described with reference to the following embodiments. As is apparent by these descriptions, this invention can be embodied in different forms and should not be construed as limited to the embodiments set forth herein. Rather, these embodiments are provided so that this disclosure will be thorough and complete, and will fully convey the scope of the invention to those skilled in the art. For example, features illustrated with respect to one embodiment can be incorporated into other embodiments, and features illustrated with respect to a particular embodiment may be deleted from the embodiment. In addition, numerous variations and additions to the embodiments suggested herein will be apparent to those skilled in the art in light of the instant disclosure, which do not depart from the instant invention. Hence, the following specification is intended to illustrate some particular embodiments of the invention, and not to exhaustively specify all permutations, combinations, and variations thereof.

According to the present invention, an animal litter is provided that includes pieces of material for the accommodation of animal waste and encourage localized animal urine and feces disposal by simulating the natural instincts of animals to excrete in soft soil for easy burial. The pieces of material can be poured from a bag as a free-flowing pellet. It is appreciated that inventive compositions are also operative as animal bedding.

According to embodiments, an inventive organic material pellet includes feedstock pieces of at least two of: a paper material, a wood material, an agricultural waste material, and a cellulosic material combined together and formed into a plurality of pellets each having a diameter of 2 to 25 mm and a length of 2 to 100 mm and having a pellet durability index (PDI) of 30% to 100%. According to embodiments, a majority of the components of the inventive animal litter or bedding pellets are from recycled materials or waste materials, that is, according to some embodiments the pellets are composed of at least more than 50% upcycled and virgin materials or waste materials.

According to embodiments, the paper material of the organic material pellet is a virgin, recycled, or waste paper material or a paper derivative. According to embodiments, the paper material is present in an amount of 0 to 99 total weight percent of an inventive litter pellet.

According to embodiments, the wood material of the organic material pellet is a virgin, recycled, or waste wood material, such as saw dust, wood scraps, wood shaving, wood chips, and the like. According to embodiments, the wood material is selected from any species of wood and may be a combination or at least two different species of wood. According to embodiments, the wood material is present in an amount of 0 to 99 total weight percent of an inventive litter pellet.

According to embodiments, the agricultural waste material of the organic material pellet is an agricultural waste material, such as pulps, rinds, pits and seeds, wheat and corn mids and dust, including but not limited to cellulosic plant hulls such as, grain hulls, nut hulls, sunflower hulls, oat hulls, spelt hulls, soy hulls, and rice hulls; corncob; crushed hemp seed; cellulosic plant stalks; plant stocks; cellulosic plant husks such as bamboo, coconut, psyllium, and corn; beeswing, wheat bran; tree bark; fronds; miscanthus; grasses; straw; kenaf; vegetable and fruit wastes such as orange peels. According to embodiments, the agricultural waste material is present in an amount of 0 to 99 total weight percent of an inventive litter pellet.

According to embodiments, the cellulosic material of the organic material pellet is a virgin, recycled, or waste cellulosic material or a paper derivative. According to embodiments, the cellulosic material is present in an amount of 0 to 99 total weight percent of an inventive litter pellet. According to embodiments, the cellulosic material includes, but is not limited to, celluloses such as carboxymethylcellulose, ethylcellulose, hydroxyethylcellulose, hydroxy-methylethylcellulose, hydroxyethylpropylcellulose, methylhydroxyethyl-cellulose, methylcellulose; cellulosic plant hulls such as, grain hulls, nut hulls, sunflower hulls, oat hulls, spelt hulls, soy hulls, and rice hulls.

According to embodiments, the feedstock pieces prior to inclusion in a pellet form have a size of 2 to 25 mm diameter and 2 to 100 mm length. According to embodiments, properly sized inbound raw material feedstock is fed directly to a pellet mill (size HP of pellet mill). Alternatively, the feedstock is first milled to a size of −400 to +2 US Standard screen sieve size. According to embodiments, the feedstock is hammermilled, pin milled, knife milled, air milled, cryogenic milled, roller milled, attrition milled, or subjected to another particle size reduction process, such as a pulverizer, prior to introduction to the pellet mill. According to embodiments, the milled or presized feedstock that is introduced to a pellet mill has a size where 90% by weight or more of the milled feedstock is between −10 and +350 U.S. Standard screen sieve size, and preferably −400 to +2 U.S. Standard screen sieve size. In some inventive embodiments, steam is utilized to release the available lignin content.

According to embodiments, the properly sized feedstock and/or milled feedstock is then introduced to a pellet mill and a pellet die. According to embodiments, the pellet die has a length in the range of 8 to 96 inches. According to embodiments, the resulting pellets each have a diameter of 2 to 25 mm and a length of 2 to 100 mm and having a pellet durability index (PDI) of 30% to 100%. A PDI is a standardized parameter for specifying the ability of pellets to resist degradation caused by shipping and handling. PDI is calculated by taking a pellet sample of about 1100 grams; screening the sample to remove fines and weigh; tumbling 500 grams of the screened sample for 500 rotations at 50+/−2 RPM; rescreening the sample, removing fines, and reweighing; repeating the tumbling with another 500 gram sample; and calculating the PDI by dividing the final pellet weight by the initial pellet weight and multiplying by 100.

The inventive organic material pellet additionally includes additive pieces. According to embodiments, the additive pieces include additional non-mineral feedstock, additional mineral feedstock, or a combination thereof, the aforementioned agglomerated with a binder. Representative non-mineral feedstock present in the additive pieces illustratively include hemp, guar, paper, aspen wood, corncob; crushed hemp seed; cellulosic plant stalks; plant stocks; cellulosic plant husks such as coconut, psyllium, and corn; cellulosic plant hulls such as grain hulls, nut hulls, sunflower hulls, oat hulls, spelt hulls, soy hulls, and rice hulls; beeswing wheat bran; tree bark; fronds; miscanthus; grasses; straw; saw dust; wood shavings; kenaf; and finely divided granules of any of the aforementioned that are then agglomerated to form a piece of litter, and combinations thereof. Representative mineral feedstock present in the additive pieces illustratively include dolomite, zeolite, limestone, perlite, diatomaceous earth, Fuller's earth, bentonite, attapulgite; montmorillonite, cleosite, granite, gypsum, aluminum sulfate, vermiculite, and combinations thereof. Representative binders present in the additive pieces illustratively include carbohydrates such as monosaccharides, disaccharides, oligosaccharides and polysaccharides; proteins; lipids; glycolipid; glycoprotein; lipoprotein; and combinations and derivatives of these. Specific carbohydrate binders illustratively include glucose, mannose, fructose, galactose, sucrose, lactose, maltose, xylose, arabinose, trehalose and mixtures thereof such as corn syrup; celluloses such as carboxymethylcellulose, ethylcellulose, hydroxyethylcellulose, hydroxy-methylethylcellulose, hydroxyethylpropylcellulose, methylhydroxyethyl-cellulose, methylcellulose; starches such as amylose, seagel, starch acetates, starch hydroxyethyl ethers, ionic starches, long-chain alkyl starches, dextrins, amine starches, phosphate starches, and dialdehyde starches; plant starches such as corn starch and potato starch; other carbohydrates such as pectin, amylopectin, xylan, glycogen, agar, alginic acid, phycocolloids, chitin, gum arabic, guar gum, gum karaya, gum tragacanth and locust bean gum; complex organic substances such as lignin and nitrolignin; derivatives of lignin such as lignosulfonate salts illustratively including calcium lignosulfonate and sodium lignosulfonate and complex carbohydrate-based compositions containing organic and inorganic ingredients such as molasses.

According to embodiments, the additive pieces are formed as granules. Milling the components of the additive pieces to granules is readily accomplished with a commercially available milling machine, hammer mill, pin mill, knife mill, air mill, cryogenic mill, roller mill, extruder, or pulverizer. A Champion hammer milling machine (Waterloo, Iowa) is representative of such a milling machine. The milled granular additive pieces desired to be agglomerated into a piece is then directed to a pan agglomerator in concert with the binder. Agglomerated pellet milling is also operative herein. The milled granular additive is delivered to the pan agglomerator by way of a conventional conveyance system that lessens dust production. According to embodiments, the milled granule additive pieces have a granule size where 90% by weight or more of the granules are between −5 and +60 screen sieve. Alternatively, the milled granular additive pieces are delivered to an extruder operating with at least one suitably sized die opening. The extruded rod of additive materials is cut into cylindrical granules and dried to achieve a desired granule size where 90% by weight or more of the granules are between −5 and +60 screen sieve. Cite the

[symbol]

According to embodiments, the additive pieces are ECOGRAN® granules produced by The Andersons, Inc. and are detailed in U.S. Pat. No. 8,074,604. The granule's basic structure is a lightweight, wood or corncob fiber core infused with a variety of additives, making ECOGRAN® granules a superior, biodegradable, all-natural granule additive. According to embodiments, the additive pieces are present in an amount of between 40 to 50 total dry weight percent of the litter composition.

According to embodiments, the inventive organic material pellet includes biochar intermixed with the aforementioned feedstock. In still other inventive embodiments, the biochar is agglomerated with the pieces of feedstock material and the additive pieces for the accommodation of animal waste. Biochar is a charcoal-like material that is produced from plant materials such as grass, agricultural and forest residues that are decomposed at high temperatures by pyrolysis of biomass in the absence of oxygen. During the process, the physical and chemical properties of the plant material change into a highly porous, stable, carbon-rich material known as biochar. It has been surprisingly found that biochar has excellent odor neutralizing properties not found in other materials. That is, because biochar, in contrast to carbon black from sooting, retains the channel structure of the base plant material, which creates a capillary draw of fluid into the internal channels of the biochar, the biochar draws animal urine into the biochar, thereby neutralizing the odor associated with degraded urine. Notably, other carbon based materials such as carbon black do not exhibit such a channel structure, and accordingly do not create the capillary draw that is present in biochar.

According to some inventive embodiments, the biochar is agglomerated into the litter pellets, while according to further embodiments, the biochar is present as a separate component within the litter. According to embodiments, the biochar is treated and/or filled with a material to further neutralize urine ammonia. For example, according to embodiments, the biochar is seeded with microbes that convert ammonia into nitrates. For example, the biochar is seeded with nitrifying bacteria, which are a small group of aerobic bacteria (family Nitrobacteraceae) that use inorganic chemicals as an energy source. They are microorganisms that convert ammonia to nitrates. The nitrification process requires the mediation of two distinct groups: bacteria that convert ammonia to nitrites (Nitrosomonas, Nitrosospira, Nitrosococcus, and Nitrosolobus) and bacteria that convert nitrites (toxic to plants) to nitrates (Nitrobacter, Nitrospina, and Nitrococcus).

According to other inventive embodiments, the biochar has an acidic pH of less than 7, which is particularly well suited for neutralizing urea and associated byproducts such as ammonia and trimethylamine. According to other inventive embodiments, the biochar is present in an amount of between 1 to 20 total dry weight percent of the litter composition. The biochar is present in this amount in order to balance the competing interests of providing sufficient absorption of animal urine while not over absorbing other elements present in the litter such as a fragrance that may be present. According to embodiments, the biochar is present in the form of particles having a size between −8 (2380 microns) to +80 mesh (177 microns). The biochar being provided within this particle size range balances the competing interests of providing a comfortable litter that is not too rough on the large size and limiting animal tracking of dust out of the litter box on the small size. According to certain inventive embodiments, the biochar is densified to approximately 30 lbs./ft³ such that the biochar has a density similar to that of the feedstock pieces and the additive pieces to avoid the biochar settling and separating out from the feedstock pieces and the additive pieces of the litter. According to embodiments, the biochar is coated to give the biochar a specific color. For example, according to embodiments, the biochar has a coating to impart a color thereto so as to avoid a speckled appear of the black biochar with other components that are lighter in color. Colors particularly well suited for the coatings of the present invention include white, blue, and gray that is creates with a white coating that is incomplete, thin, or translucent such that the biochar black color is partly perceived by the unaided, normal eye of a human observer. A coating according to the present invention includes an inorganic hydroxide such as magnesium hydroxide, and aluminum hydroxide; an inorganic carbonate, such as calcium carbonate, sodium bicarbonate, sodium hydrogen carbonate; and a blue dye or pigment. The aforementioned coatings are readily formed alone or as inclusion within a resin or binder that forms a matrix around the biochar. It is appreciated that hydroxide or carbonate coatings also contribute odor neutralizing capacity to an inventive litter.

It is appreciated that various additional additives can be incorporated into an organic material pellet according to the present invention. These additives illustratively include a colorant, a fragrance, an acid neutralizing agent, and a desiccant. When present, a colorant or fragrance is typically present from 1 ppm to 10 dry weight percent of a pellet. When present, an acid neutralizing agent is typically present from 0.05 to 10 dry weight percent of a pellet. When present, a desiccant is typically present from 0.05 to 10 dry weight percent of a pellet.

According to embodiments, the inventive organic material pellet includes an oil provided on the litter pellets. In certain inventive embodiments, the second oil facilitates the subsequent adherence of a clumping agent. In addition, the oil is operative to lessen dust formation during subsequent handling, packaging, and usage. An oil operative herein illustratively includes mineral oil, an essential oil, kerosene, vegetable oils, glycerin, paraffin distillates, naphthalene distillates, and combinations thereof. In some inventive embodiments, the second oil is added to fully coat the litter pellets. Typically, the oil is added to the pellets in an amount ranging from 0.05 to 10 total weight percent of the litter or bedding. In some inventive embodiments, the oil coating includes an essential oil that is peppermint, spearmint, wintergreen, eucalyptus, rosemary, aloe, myrrh, frankincense, clove, lavender, orange blossom, chamomile, marjoram, yarrow, sandalwood, ginger, clary sage, juniper, cajuput, camphor, cinnamon, or combinations thereof.

In some inventive embodiments, a clumping agent is adhered to the surface of the organic material pellets. A clumping agent according to the present invention is present as a particle decorating the surface of the litter pellet. Clumping agents operative herein illustratively include gums such as guar, arabic, karaya, tragacanth and locust bean; celluloses such as corn syrup; celluloses such as carboxymethylcellulose, ethylcellulose, hydroxyethylcellulose, hydroxy-methylethylcellulose, hydroxyethylpropylcellulose, methylhydroxyethyl-cellulose, methylcellulose; starches such as amylose, seagel, starch acetates, starch hydroxyethyl ethers, ionic starches, long-chain alkyl starches, dextrins, amine starches, phosphates starches, and dialdehyde starches; plant starches such as corn starch and potato starch. Typically, the clumping agent is added in the range of 0.05 to 30 total weight percent relative to the litter. It is appreciated that the clumping agent need not be present to attain an operative animal litter. Additionally, a clumping agent present at the lower ranges contemplated results in a more readily crumbled clump, whereas greater amounts of clumping agent tend towards rock-like clumps.

According to embodiments, a separate binder is present in amounts ranging from 0.5% to 95% by weight of the total dry weight of the organic material pellets. Illustrative examples of binders operative herein are carbohydrates such as monosaccharides, disaccharides, oligosaccharides and polysaccharides; proteins; lipids; glycolipid; glycoprotein; lipoprotein; and combinations and derivatives of these. Specific carbohydrate binders illustratively include glucose, mannose, fructose, galactose, sucrose, lactose, maltose, xylose, arabinose, trehalose and mixtures thereof such as corn syrup; celluloses such as carboxymethylcellulose, ethylcellulose, hydroxyethylcellulose, hydroxy-methylethylcellulose, hydroxyethylpropylcellulose, methylhydroxyethyl-cellulose, methylcellulose; starches such as amylose, seagel, starch acetates, starch hydroxyethyl ethers, ionic starches, long-chain alkyl starches, dextrins, amine starches, phosphate starches, and dialdehyde starches; plant starches such as corn starch and potato starch; other carbohydrates such as pectin, amylopectin, xylan, glycogen, agar, alginic acid, phycocolloids, chitin, gum arabic, guar gum, gum karaya, gum tragacanth and locust bean gum; complex organic substances such as lignin and nitrolignin; derivatives of lignin such as lignosulfonate salts illustratively including calcium lignosulfonate and sodium lignosulfonate and complex carbohydrate-based compositions containing organic and inorganic ingredients such as molasses. Suitable protein binders illustratively include soy extract, zein, protamine, collagen, and casein. Binders operative herein also include synthetic organic polymers capable of promoting or producing cohesion of methylene urea oligomer fines and these illustratively include ethylene oxide polymers, polyacrylamides, polyacrylates, polyvinyl pyrrolidone, polyethylene glycol, polyvinyl alcohol, polyvinylmethyl ether, polyvinyl acrylates, polylactic acid, and latex. In a preferred embodiment, the binder is calcium lignosulfonate, molasses, a liquid corn starch, a liquid corn syrup or a combination thereof.

### Method of Making Pellets

An inventive pellet is formed from properly sized feedstocks that are milled to size or unmilled yet properly sized. These feedstocks are mechanically aggregated and fed into a pellet mill. The feedstock typically have a mean granule size that is between +400 and −2 US Standard sieve size. In other embodiments, the mean aggregate domain size of the feedstock is less than 180 micrometers. These feedstocks are mechanically aggregated into pellets in a drum-granulator.

According to embodiments, a binder is present. The binder is sprayed into the drum granulator with the seed meal. The pellets are dried and size-screened with pellets of desired size being stored for bagging and usage. In some inventive embodiments, the particles are transferred to a coating drum for addition of an additive ingredient or a conditioner material.

In another embodiment, the seed meal fines are mechanically aggregated into pellets in an Eirich unit in the presence of a binder. The fines having the sizes mentioned immediately above.

Various means of drying the material are available. An exemplary method is fluid bed drying. The material is placed in a fluid bed drier and the drier inlet air temperature ranges from 120° F. to 220° F. Further methods of drying particles will be apparent to one of skill in the art and illustratively include use of a rotary drum dryer and drying under vacuum conditions.

### Association of an Additive Ingredient With a Pellet

An additive ingredient is associated with a pellet during the process of pellet formation or after pellets are formed. For example, an additive ingredient is mixed with the binder. The binder/additive ingredient mixture is added to the feedstock fines and mechanically aggregated in a pan granulator resulting in particles wherein the additive material are in suspension in the binder.

Where it is desirable to add the additive ingredient after pellet formation, for example where the additive ingredient is incompatible with suspension in the binder, the additive ingredient is added to the pellet following pellet formation in the presence or absence of an adhesive. Methods of additive ingredient addition illustratively include spraying onto the pellet or adsorption of the additive ingredient by coating the pellet in a non-aqueous solution of the additive ingredient.

In another embodiment, the additive ingredient is mixed with an adhesive before application to a pellet. An adhesive is a substance that binds to a pellet, such that the additive ingredient adheres to the pellet in suspension in the adhesive. The adhesive may be the same as the binder or different. The choice of adhesive depends on the pellet components and will be evident to one skilled in the art. Examples of adhesives include, but are not limited to, substances listed herein as binder components. Preferably, the adhesive is calcium lignosulfonate, molasses, a liquid corn starch, a liquid corn syrup or a combination of these.

For example, the additive ingredient in powdered form is adhered to the outside surface of the pellet with the use of an adhesive. An adhesive liquid may be used and is applied before or after the addition of the powdered additive ingredient or it may be applied at the same time as the additive ingredient. The choice of adhesive depends on the particle components and will be evident to one skilled in the art. Examples of a liquid adhesive include but are not limited to binders listed herein, including mineral oils or polymer liquids such as polybutene.

### Size of Pellets

The pellets of the present invention have a mean pellet domain size that ranges from 2 and 25 mm. The pellets formed by the process of the present invention have a Uniformity Index rating in the range of 30 to 60 where the Uniformity Index rating is calculated as the 10th percentile pellet size expressed as a percentage of the 95th percentile pellet size.

### Shape of the Pellets

Pellets of the present invention take any shape illustratively including spheres, cylinders, ellipses, rods, cones, discs, needles and irregular. In some inventive embodiments, such as those in which a pan agglomerator is used, the pellet are approximately spherical.

As noted above, the inventive organic material pellet is environmentally friendly in that used litter that would normally be disposed of in a landfill is reusable as a soil quality enhancer. That is, the inventive organic material pellet may be used to collect animal waste and neutralize the odor thereof and subsequently be reused to improve soil quality by providing nutrients to the soil when mixed therewith. Accordingly, the inventive organic material pellet greatly reduces the amount of non-degradable waste in landfills.

An inventive method for reusing the organic material pellet includes providing the inventive pellets in a space accessible to a subject. This may include providing the litter in a tray, such as a litter box or a cage bottom, or providing the litter or bedding on the floor of a stall or pen. According to embodiments, the pellets are accessible to the animal for urine and feces disposal to simulate the natural instincts of animals to excrete in soft soil for easy burial. The method continues by receiving liquid waste and/or solid waste in the animal litter or bedding from the subject animal. Once the liquid waste contacts the inventive litter the inventive pellet litter absorbs the liquid waste, thereby neutralizing the associated odor. An animal owner then removes the solid waste and absorbed liquid waste from the litter and disposes of the used pellet litter or bedding and absorbed liquid waste by mixing it with soil. Alternatively, the owner could dispose of the used pellet litter or bedding and absorbed liquid waste by providing it to a third party who then mixes it with soil. In the event that solid waste is present in the litter or bedding, the solid waste is removed from the litter or bedding and disposed of in the trash or a toilet.

According to embodiments, the subject is a mammal including domesticated pets, captive animals, farm animals, and sporting animals. Specific animals include a cat, dog, horse, cow, sheep, goat, llama, rodent, chicken, duck, turkey, monkey or chimpanzee. Exemplary rodents include a mouse, a rat, rabbit, a gerbil, guinea pig, or a hamster.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention but is not meant to be a limitation upon the practice thereof. The following claims, including all equivalents thereof, are intended to define the scope of the invention.

1. Organic material pellets comprising:
a plurality of feedstock pieces of at least two of a paper material, a wood material, an agricultural waste material, and a cellulosic material combined together and formed into a plurality of the organic material pellets.

2. The pellets of claim 1 wherein each of the plurality of pellets has a diameter of X to X mm and a length of Y to Y mm.

3. The pellets of claim 1 wherein each of the plurality of pellets has a pellet durability index (PDI) of 30% to 100%.

4. The pellets of claim 1 wherein the paper material is present and is a virgin, recycled, or waste paper material or a paper derivative.

5. The pellets of claim 1 wherein the paper material is present and is present in an amount of 0 to 99 total weight percent of the pellet.

6. The pellets of claim 1 wherein the wood material is present and is saw dust, wood scraps, wood shaving, wood chips, or a combination thereof.

7. The pellets of claim 1 wherein the wood material is present and is present in an amount of 0 to 99 total weight percent of the pellet.

8. The pellets of claim 1 wherein the agricultural waste material is present and includes pulps, rinds, pits and seeds, wheat and corn mids and dust, cellulosic plant hulls, grain hulls, nut hulls, sunflower hulls, oat hulls, spelt hulls, soy hulls, and rice hulls, corncob, hemp, crushed hemp seed, bamboo, cellulosic plant stalks, plant stocks, cellulosic plant husks, beeswing wheat bran, tree bark, fronds, miscanthus, grasses, straw, kenaf, vegetable and fruit wastes, orange peels, or a combination thereof.

9. The pellets of claim 1 wherein the agricultural waste material is present and is present in an amount of 0 to 99 total weight percent of the pellet.

10. The pellets of claim 1 wherein the cellulosic material is present and includes a carboxymethylcellulose, ethylcellulose, hydroxyethylcellulose, hydroxy-methylethylcellulose, hydroxyethylpropylcellulose, methylhydroxyethyl-cellulose, methylcellulose, cellulosic plant hull, grain hull, nut hull, sunflower hull, oat hull, spelt hull, soy hull, rice hull, or a combination thereof.

11. The pellets of claim 1 wherein the cellulosic material is present and is present in an amount of 0 to 99 total weight percent of the pellet.

12. The pellets of claim 1 wherein the pellets are adapted to be poured from a bag or flexible packaging, jug, pail or bucket, cannister.

13. The pellets of claim 1 wherein the feedstock pieces are granules and comprise a granule particulate that is 90% by weight or more able to pass −2 screen sieve.

14. The pellets of claim 1 wherein feedstock pieces are a majority by weight of recycled materials or waste materials.

15. The pellets of claim 1 further comprising a plurality of additive pieces including additional non-mineral feedstock, additional mineral feedstock, a binder, or a combination thereof.

16. The pellets of claim 15 wherein the binder is starch.

17. The pellets of claim 1 further comprising a biochar.

18. The pellets of claim 17 wherein the biochar has an acidic pH of less than 7.

19. The pellets of claim 1 further comprising a clumping agent.
